(19) United States
(12) Patent Application Publication
(10) Pub. No.: US 2002/0073124 A1
(43) Pub. Date: Jun. 13, 2002

(54) Network browser

(76) Inventors: Takahiro Masuda, Kawasaki (JP); Yoshifusa Togawa, Kawasaki (JP)

Correspondence Address: STAAS & HALSEY LLP, 700 11TH STREET, NW, SUITE 500, WASHINGTON, DC, 20001, US

(21) Appl. No.: 09/873,368

(22) Filed: Jun. 5, 2001

(30) Foreign Application Priority Data
Dec. 11, 2000 (JP) 2000-376500

(51) Int. Cl. G09G 5/00; G06F 15/00

(52) U.S. Cl. 707/526; 345/214; 709/203

(57) ABSTRACT

There is provided a browser and browsing method enable efficient WWW browsing on the Internet. When a resource file prescribed by a display control file such as an HTML file is read by using an Internet browser or the like, the resource file is analyzed and another file described in the resource file is downloaded from a server and loaded into an invisible on-screen data area before an instruction is provided from a user to download the file. The contents of descriptions on a source page are analyzed, a module necessary for an identified file according to the characteristics of the file is previously downloaded, and a viewer's will is conjectured from the position of a cursor, the state of movement of the cursor, etc., to execute file prereading under a particular condition, thus enabling prereading according to the viewer's will.

### BACKGROUND OF THE INVENTION

1. Field of the Invention

The present invention relates to a technique effectively used by being applied to a browser program for browsing resources through a network, e.g., the Internet.

2. Description of the Related Art

Netscape (trade name) produced by Netscape Corporation, Internet Explorer (trade name) produced by Microsoft Corporation, etc., are known as browser programs for browsing Internet World Wide Web (WWW) sites.

These browsers have the function of outputting source files written in Hyper Text Mark-up Language (HTML) format to a terminal together with still images, moving images, speech information, etc., related (linked) to the source file to enable a user to browse them.

One of the features of the HTML resides in enabling setting of a link in a certain way of description, whereby a hierarchical hypertext is realized on a network.

To effect a move from one page (an amount of information defined in accordance with the HTML to be displayed on the screen) to another page, a mouse button or the like is clicked on a portion of the source page at which a link from the source page is defined. Reading of a file from the link destination is thereby triggered.

In the case of a file of a large size, e.g., 1 Mbytes or more at a link destination, therefore, a substantially long time, several ten seconds to several minutes, depending upon communication quality, is required to complete reading and display of the file on the browser.

By considering this problem, a technique such as the one disclosed in Japanese Patent Application Laid-open No. Hei 10-222541 has also been proposed which comprises previously reading to a local storage area, HTML files and image files having links from a source page when the source page is designated.

According to this method, when a user reads a source page, files having uncertain probabilities of being selected as a target of linkage executed by the user are previously read collectively, so that the possibility of wastefully consuming the storage area of a buffer or the like is high.

Because all linked files are previously read, there is a possibility of the preread of the link-destination files being incomplete even after reading of the source page has been completed. In such a case, it is possible that a move to a different page (reading of a new page) will be delayed because of the continuation of execution of the preread process.

Therefore, this kind of file preread function can be used only in particular programs such as those for automatically and periodically accessing predetermined source pages during a low-telephone-charge time period at midnight.

### SUMMARY OF THE INVENTION

In view of the above-described circumstances, an object of the present invention is to provide a browser capable of performing preread according to a viewer's will in such a manner that the contents of a description on a source page are analyzed and necessary modules are previously loaded according to the characteristics of the analyzed file, and that the viewer's will is conjectured from the position of a cursor, the state of movement of the cursor, etc., to execute file prereading under a particular condition. Thereby a browser capable of prereading in accordance with the viewer's will may be provided.

According to the present invention, when a resource file prescribed by a display control file such as an HTML file is read by using an Internet browser or the like, the resource file is analyzed and another file described in the resource file is downloaded from a server and loaded into an invisible area before an instruction is provided from a user to download the file.

More specifically, analysis means for analyzing the display control file for managing a display screen to extract a description of another file is provided. Another file identified by this analysis is downloaded from the server and is loaded onto an invisible screen. When the another file described in the display control file is designated on the display screen, the another file downloaded onto the invisible screen is executed or displayed without newly downloading the another file.

At this time, if the file requires a particular module, the module may be loaded.

To enable the above-described analysis processing, an operation on the display screen may be monitored. The analysis processing may be performed only after no mouse or keyboard operation has been performed during a certain time period.

The analysis of the display control file or downloading of another file may be started if a mouse cursor has stayed within a certain area for a certain time period. A plurality of files placed subordinate to one high-level directory may be collectively downloaded from the server.

According to the present invention, the contents of the descriptions on a source page are analyzed, a module necessary for an identified file according to the characteristics of the file is previously downloaded, and a viewer's will is conjectured from the position of a cursor, the state of movement of the cursor, etc., to execute file prereading under a particular condition, thus realizing a browser capable of prereading according to a viewer's will.

### BRIEF DESCRIPTION OF THE DRAWINGS

In the accompanying drawings:

FIG. 1 is a functional block diagram of Embodiment 1 of the present invention;

FIG. 2 comprises diagrams showing the states of a display screen and an invisible on-screen data area in Embodiment 1 of the present invention;

FIGS. 3 comprises flowcharts respectively showing a control process and a downloading process in Embodiment 1 of the present invention;

FIG. 4 is a flowchart showing the order of file name stacking in a work list, an analysis target list and a non-analysis-target list in Embodiment 1 of the present invention;

FIG. 5 is a diagram showing the format of each list in Embodiment 1 of the present invention;

FIG. 6 is a diagram showing an example of a description of a Java class file of Embodiment 1 of the present invention;

FIG. 7 is a diagram showing an example of a description of a Java script;

FIG. 8 is a functional block diagram of Embodiment 2 of the present invention;

FIG. 9 is a diagram showing the states of a display screen and an invisible on-screen data area in Embodiment 2 of the present invention;

FIG. 10 is a functional block diagram of Embodiment 3 of the present invention;

FIG. 11 comprises diagrams showing the states of a display screen, an invisible on-screen data area and a correspondence table in Embodiment 3 of the present invention;

FIG. 12 is a functional block diagram of Embodiment 4 of the present invention;

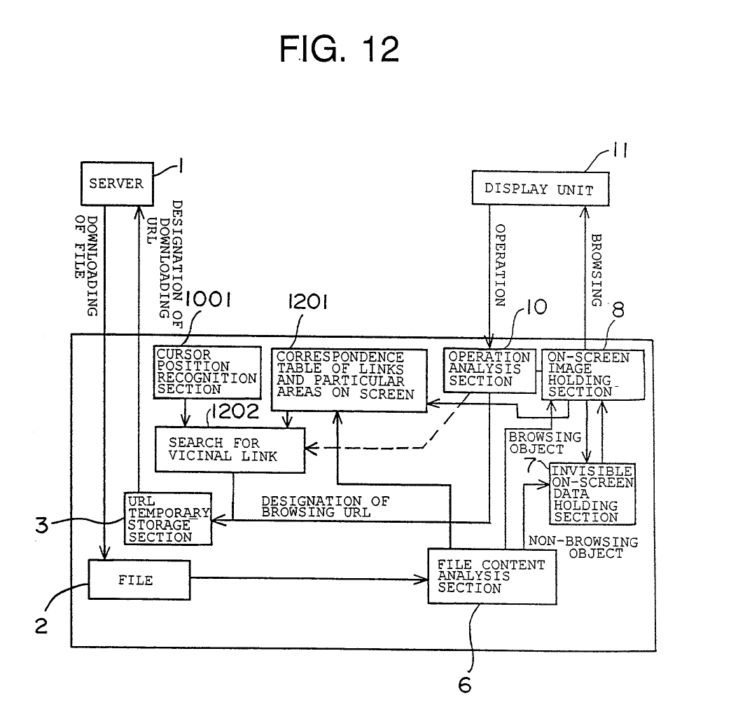

FIG. 13 comprises diagrams showing the states of a display screen, an invisible on-screen data area and a correspondence table in Embodiment 4 of the present invention;

FIG. 14 is a functional block diagram of Embodiment 5 of the present invention;

FIG. 15 comprises diagrams showing the states of a display screen, an invisible on-screen data area and a correspondence table in Embodiment 5 of the present invention;

FIG. 16 comprises diagrams showing the states of a display screen, an invisible on-screen data area and a correspondence table in a modification of Embodiment 5 of the present invention;

FIG. 17 comprises diagrams showing states before and after updating of the invisible on-screen data area in the embodiments; and

FIG. 18 comprises diagrams respectively showing a change in a display on the display screen and a change of a cursor in the embodiments.

### DESCRIPTION OF THE PREFERRED EMBODIMENTS

Embodiments of the present invention will be described with reference to the accompanying drawings.

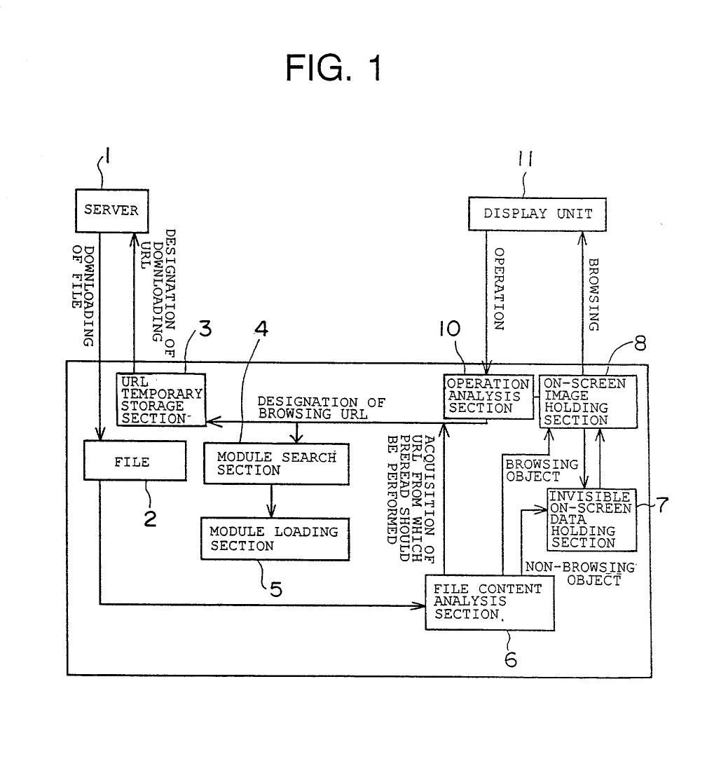

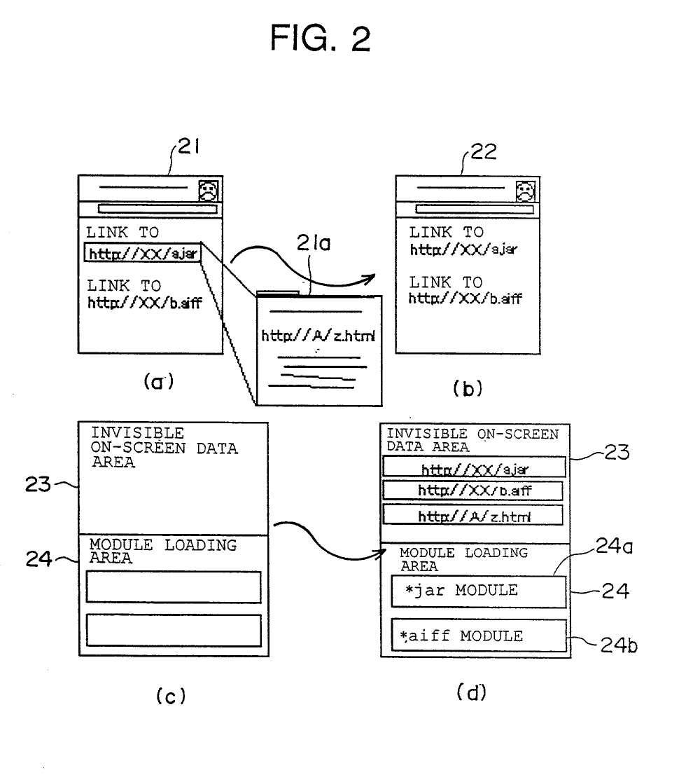

FIG. 1 is a functional block diagram of a browser system which represents an embodiment of the present invention. FIG. 2 is a diagram showing the concept of area division in an invisible on-screen data holding section and in a module loading section of the storage region.

Referring to FIG. 1, a server 1 constitutes a World Wide Web (WWW) server on a data transfer system based on the Internet, i.e., the Transmission Control Protocol/Internet Protocol (TCP/IP) system.

The browser system operates in a terminal which is connected to the server 1 through a network, and which is constituted by a personal computer or the like.

The terminal has a display unit 11, on which a page having links set as shown in (a) of FIG. 2 is displayed. A link designated on the page (http://XX/a.jar) includes a Uniform Resource Locator (URL) designation file 21a.

When a user performs a predetermined operation, e.g., an operation for displaying a particular home page (shown in (a) of FIG. 2) written in HTML through the display unit 11, an operation analysis section 10 analyzes the details of the operation. Specifically, this analysis is performed to obtain the URL of the page displayed on the operating unit 11 according to the operation performed by the user. In the example shown in FIG. 2, a file 21 is obtained.

The URL thereby obtained is temporarily stored in a URL temporary storage section 3 which is a buffer. The server 1 designated by the URL successively read out is accessed. Next, a file 2 having this URL (a source file having the same URL as the page presently indicated on the display unit 11) is downloaded from the server 1. The file 2 is loaded into a memory of the personal computer without being perceived by the user. The file 2 (the source file corresponding to the URL indicated on the display unit 11) is analyzed by the file content analysis section 6.

If the result of the analysis is that there is a URL (such as URL 21a shown in FIG. 2) from which a preread should be performed, the URL is temporarily stored in the URL temporary storage section 3 and the server 1 is accessed on the basis of the URL. “URL from which a preread should be performed” denotes a URL written as a link destination in the above-described source file displayed on the display unit 11.

When the server 1 is accessed on the basis of the URL temporarily stored in the URL temporary storage section 3, a file (HTML file) designated by the URL is downloaded and the contents of this file are analyzed by the file content analysis section 6. By analyzing this file (HTML file), the file content analysis section 6 makes a determination as to whether there is a file designation such as one for a moving image file or a speech file requiring a reproducing module. If a module of such a kind is required, it is read to a storage area of the personal computer through a module search section 4 and a module loading section 5. In an example of memory contents shown in (d) of FIG. 2, a jar module 24a for Java and an aiff module 24b for speech are loaded.

The file content analysis section 6 then loads the downloaded file into an invisible on-screen data holding section 7. The invisible on-screen data holding section 7 and the module loading section 5 are set in the storage area of the personal computer, as shown in (c) and (d) of FIG. 2. That is, the invisible on-screen data holding section 7 and the module loading section 5 are secured as an invisible on-screen data area 23 and a module loading area 24, respectively.

Referring to (d) of FIG. 2, a Java file (jar), a speech file (aiff) and a character display file (html) are loaded into the invisible on-screen data area 23 (invisible on-screen data holding portion 7).

While the page (in (b) of FIG. 2) having the above-mentioned source URL is being displayed on the display unit 11, the file analyzed by the file content analysis section 6 may be designated by the user operating a mouse or the like before loading of the preceding file into the invisible on-screen data holding section 7 is completed. In such an event, the file content analysis section 6 immediately loads the designated file into an on-screen image holding section 8 without loading it into the invisible on-screen data holding section 7.

If the display unit 11 is allowed to continue displaying the page (in (b) of FIG. 2) having the above-mentioned source URL, the file content analysis section 6 loads the file into the invisible on-screen data holding section 7, as described above (see (d) of FIG. 2).

When the file loaded into the invisible on-screen data holding section 7 is designated by the user operating the mouse or the like on the display unit 11 after the completion of loading of the file, the operation analysis section 10 loads into the on-screen image holding section 8 the file held in the invisible on-screen data holding section 7 without accessing the server 1, thereby immediately displaying the preread file on the display unit 11.

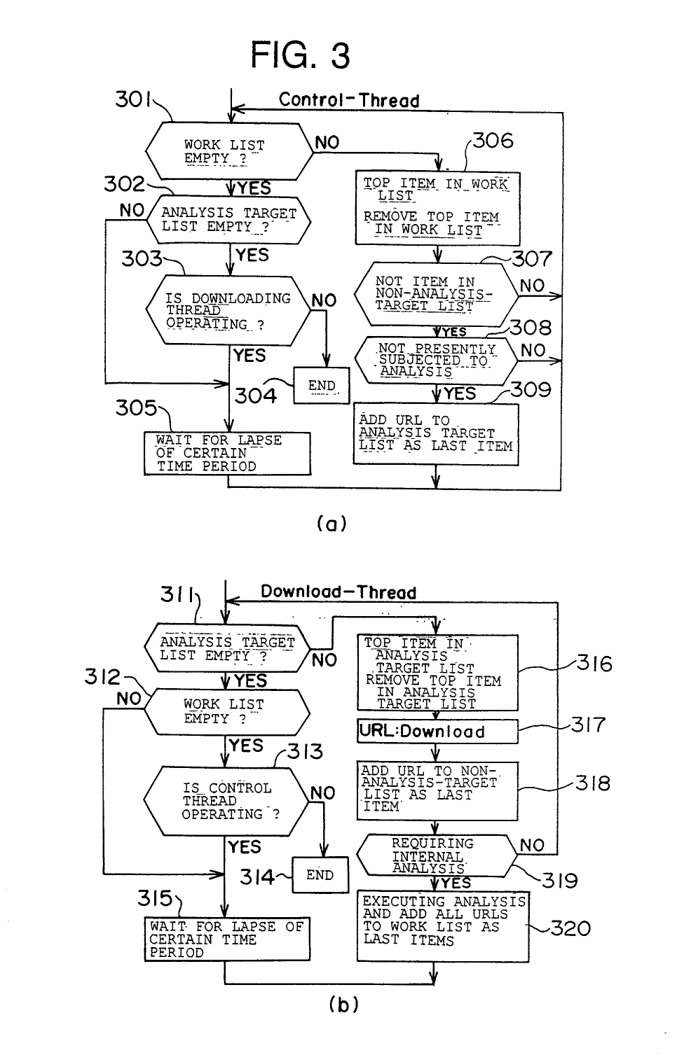

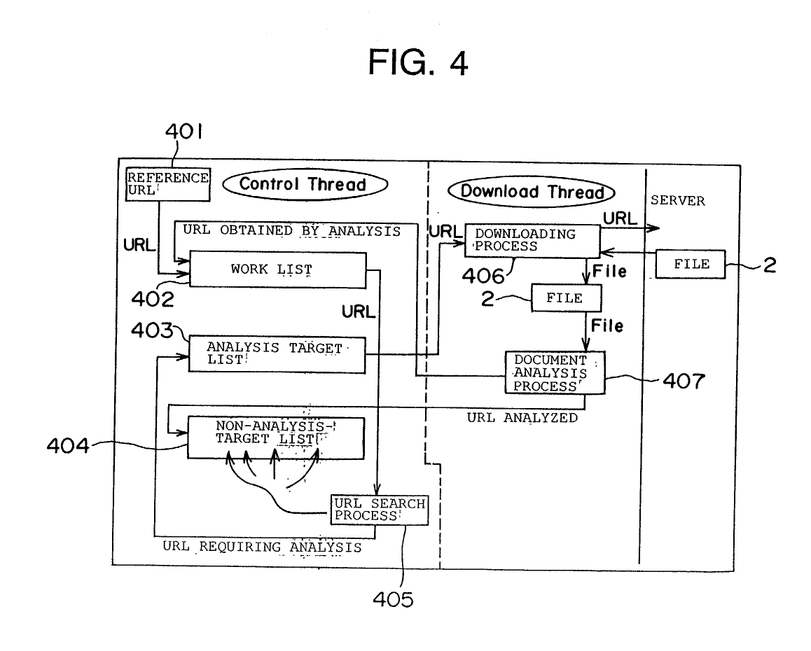

An analysis process performed by the operation analysis section 10 and the file content analysis section 6 will next be described with reference to FIGS. 3, 4, and 5.

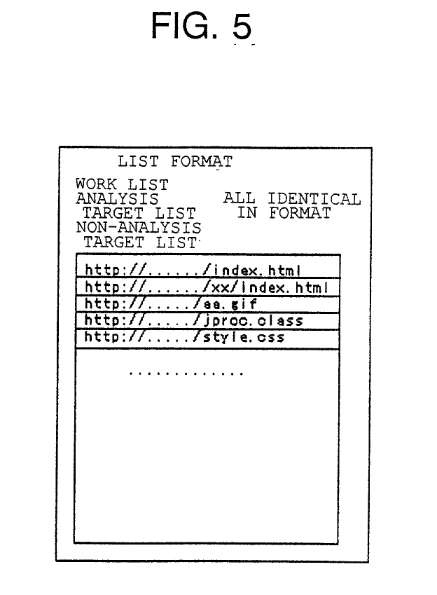

The operation analysis section 10 first initializes (makes empty) an analysis target list 403, a non-analysis-target list 404, and a work list 402. The analysis target list 403 is a list in which URLs which need analysis are successively stored. The non-analysis-target list 404 is a list in which URLs (files) from which files have already been downloaded and, which need no reanalysis are registered. The work list 402 is a list used for processing of URLs. These lists have the same format and URL (file) names can be registered in table format such as shown in FIG. 5 in each list.

At a preparatory stage before analysis, a reference URL (the URL of a page displayed on the display unit 11) is written to the empty work list.

Subsequently, a control process (FIG. 3(a)) or a downloading process (FIG. 3(b)) is separately performed.

In the control process, a determination is first made as to whether the work list 402 is empty (step 301). Immediately after the above-described initialization, since the work list 402 is empty, a determination is made as to whether the analysis target list 403 is empty (302). If both the work list 402 and the analysis target list 403 are empty, and if downloading has not been performed (303), the process ends.

On the other hand, if URLs have been accumulated in the work list 402, the URL at the top of the work list 402 is read out (306) and a check is made as to whether the URL has been registered in the non-analysis-target list 404. If no match is found in the non-analysis-target list 404 and it is thereby determined that the URL needs analysis (307), a determination is then made as to whether it is presently being analyzed (308). If the URL is not being analyzed, it is added to the analysis target list 403 (309) and the process returns to step 301.

When the URL (file) is added to the analysis target list as described above, the process branches off by determination in step 302, and a lapse of a certain time is awaited (305).

In the downloading process (FIG. 3(b), the analysis target list 403 is first checked (311). If URLs (files) have been registered as in the above, the URL (file 2) at the top of the analysis target list 403 is loaded and registered in the URL temporary storage section 3 and accessing to the server 1 based on this URL (file 2) is performed (317). When a downloading process 406 for downloading the URL (file 2) is executed, the analysis of the URL (file 2) is completed and the URL (file 2) is added to the non-analysis-target list 404 as a last item in the list (318).

The file content analysis section 6 then executes a document analysis process 407 for analyzing the URL (file 2) downloaded in the above-described step 317. More specifically, in the document analysis process 407, the file contents are checked for determination as to whether the file needs internal analysis like an image file or the like. If the URL (file 2) needs no analysis, it is added to the non-analysis-target list 404, as described above, and the process then returns to step 311 (319).

If the result of analysis of the downloaded URL (file 2) is that the URL (file 2) contains descriptions of URLs like a Java file or the like, all the contained URLs (files) are added to the work list 402 as last items (320). Consequently, these files are added to the analysis target list 403 as working objects in the next control process (FIG. 3(a)).

An example of the document analysis process (407) performed by the operation analysis section 10 or the file content analysis section 6 will next be described.

In the document analysis process, there is no need for preread of resources using protocols other than http, such as ftp, nntp, etc., and such resources are not set as preread objects.

Generally, URLs are described in the form of “[protocol name]://[server name][:port]/[path name]”, e.g., “http://www.fujitsu.co.jp/xxx/yyy/zzz.html”. Therefore the necessary protocol for a resource having such a URL can be ascertained by analyzing the URL.

In the case of analysis of a resource having such a URL, if the resource has such a document format as to be readable as text information like HTML or various scripts contained in HTML, the portion described as the URL may be extracted. For example, if there is a description

“<ahref=”http://www/xxx.com/yyy/zzz.html“>”,

“http://www/xxx.com/yyy/zzz.html” is extracted as a URL (file).

With respect to a binary file not directly readable as text information, the following analysis may be performed.

There is a possibility of files in a file format such as “*.class” or “*.jar” in Java format, containing an internal URL description. There is also a strong possibility of an internal URL description being contained in various document files containing microscripts and in files of a server-client linked execution type in Active X format, as well as in such Java class files.

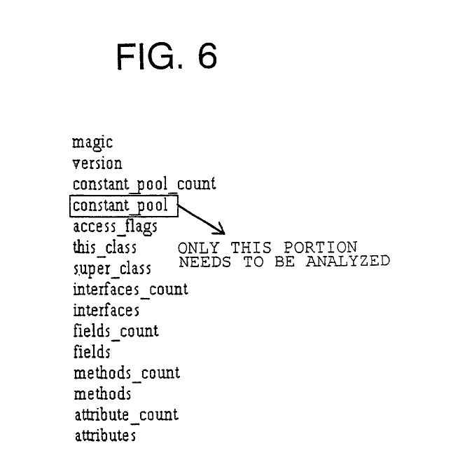

Java class files are of a structure such as shown in FIG. 6. A Java class file may be analyzed by checking whether the constant pool area in the structure contains values matching the proper URL pattern, and matching values may be regarded as a URL to be loaded. Referring to FIG. 6, only a portion “constant#pool” may be analyzed.

Most of files in other formats probable to contain URL descriptions contain URLs as character string constants. The corresponding portion to be extracted from such files can be detected by pattern matching of the character string.

It is not necessary to analyze files generally improbable to contain URL descriptions, e.g., image files such as “*.jpg”, “*.bmp”, and “*.gif”. Moving image files (mov, mpg, etc.), speech files (wav, mid, etc.), as well as such image files, may also be regarded as excludable from the analysis objects.

Portions expressed in the tagged form in HTML documents are regarded as objects to be analyzed in the document analysis process 407. An HTML document is constituted by two portions: “tags (including a comment)” and “ordinary text”. Even if an HTML document is described as a script or an object, any of its portions is a tag or a text. A description of a text portion is visually recognized by the user through the browser program, and tags are descriptive portions provided as a partial coordination attribute of a text for designating a link destination or a file. In this embodiment, therefore, only tags may be analyzed.

Further, tags are separated into “tag name”, “attribute name”, “attribute value”, and “others (comment, =, “, /, etc.)” For example, a description “<imgsrc=”pic.jpg“alt=”picture“>” is made. In this example, “img” is a tag name”, “src” and “alt” are attribute names, and ““pic.jpg”” and ““picture”” are attribute values.

Such attribute names are further separated into “those corresponding to attribute values which cannot be URLs”, “those corresponding to attribute values probable to be URLs”, and “those corresponding to attribute values which are always URLs”. Therefore, the patterns may be analyzed with respect to only attribute values probable to be URLs. When an attribute value matching a URL is found, the corresponding resource (file) may be downloaded from the server 1.

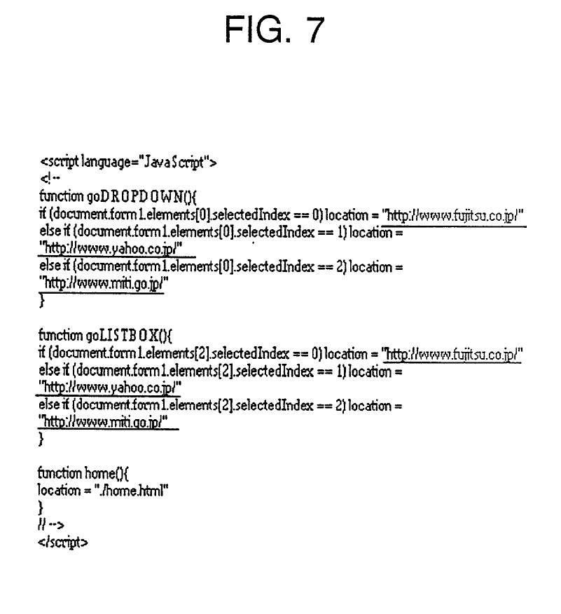

FIG. 7 shows an example of a description of a Java script. The description shown in FIG. 7 is made in such a manner that a certain form is prepared and a move to a particular link destination is realized by object operation in this form. To realize a link by a Java script, a URL for a link destination is ordinarily given in the form of a character string constant as indicated by each of the underlined portions in FIG. 7. In this example, character strings beginning with “http://” are extracted by pattern matching to analyze a link destination.

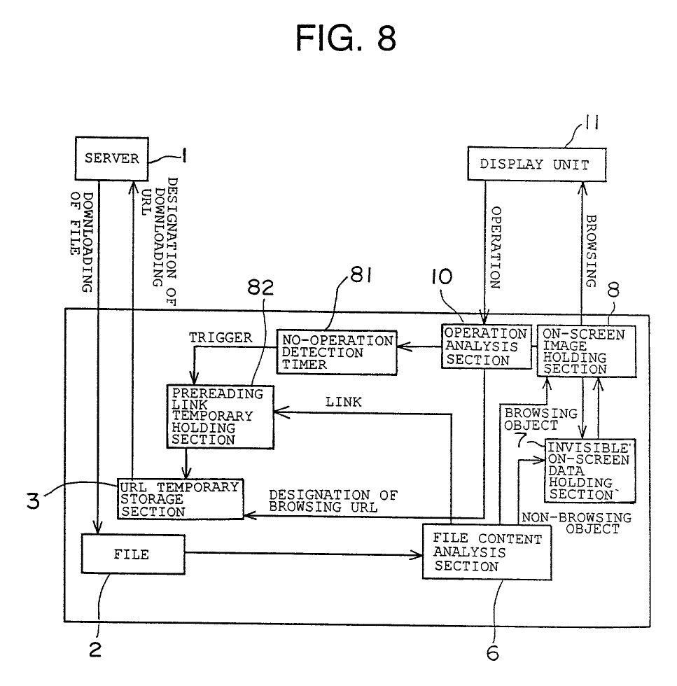

FIG. 8 is a functional block diagram showing another embodiment of the present invention.

This embodiment relates to a technique for starting preread of a URL (file) by detecting a period of time through which a cursor on a display screen is stopped.

In this embodiment, accessing the server 1 for a preread based on a URL stored in the URL temporary storage section 3 is started after a lapse of a certain time period timed by a no-operation detection timer 81. The no-operation detection timer 81 provided in this embodiment is reset by the operation analysis section 10. The operation analysis section 10 monitors the mouse operation on the display unit 11 performed by the user and resets the timer 81 to a start of timing when the movement of a cursor 93 with the mouse is stopped. When a certain time period (e.g., 10 seconds) lapses without any cursor movement, the timer 81 outputs a trigger signal to a prereading link list holding section 82 to notify the URL temporary storage section 3 of an URL held in the holding section 82. The URL temporary storage section 3 executes accessing the server 1 according to this notice.

Processing in each of the operation analysis section 10 and the file content analysis section 6 is the same as that in the embodiment shown in FIGS. 1 through 7, and the description for it will not be repeated.

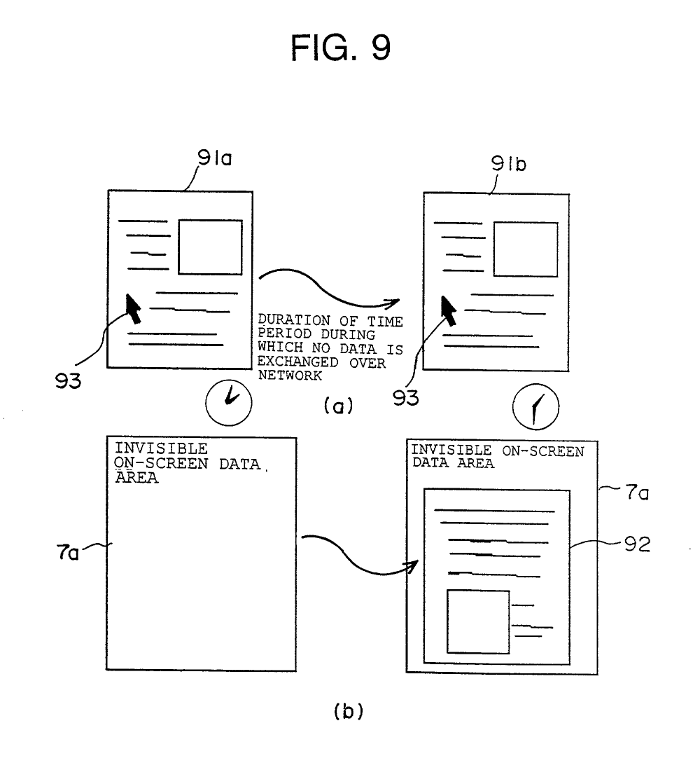

FIG. 9(a) shows a state in which the cursor 93 is not moved on the display unit 11 during a certain time period, and FIG. 9(b) shows a state in which the no-operation detection timer 81 detects the state shown in FIG. 9(a), a URL (file 92) to be preread is downloaded from the server 1 to be held in the invisible on-screen data area 7a constituting the invisible on-screen data holding section 7.

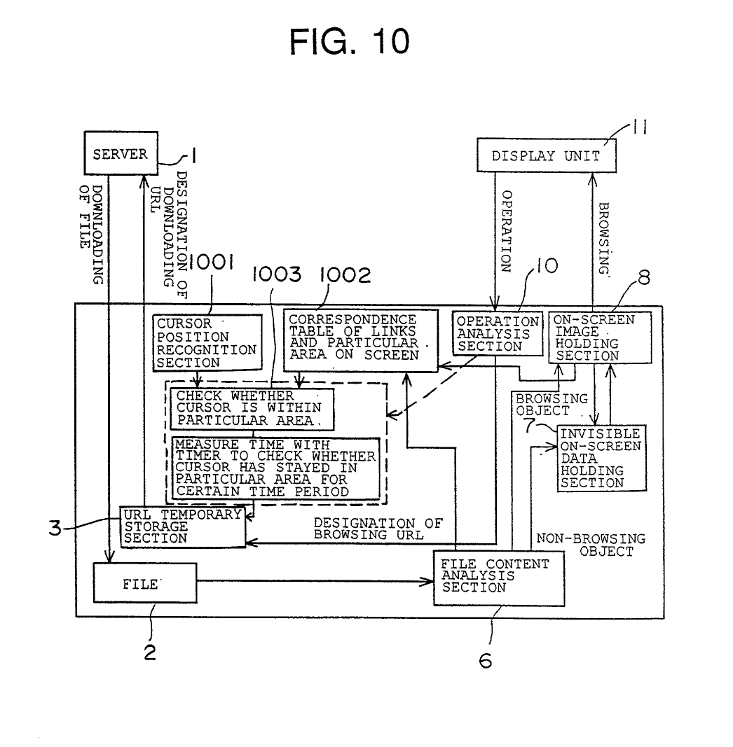

FIG. 10 is a functional block diagram showing still another embodiment of the present invention.

This embodiment relates to a technique for executing preread of a URL (file) in a case where, even if a cursor is moved during a certain time period, the movement of the cursor is limited within a certain area on a display screen.

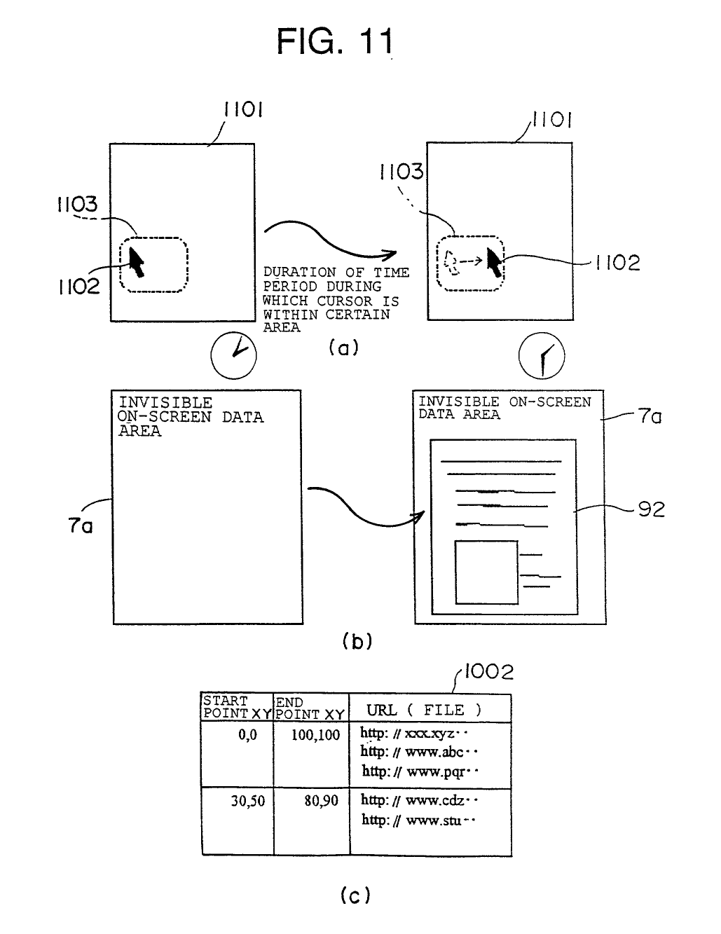

In this third embodiment, a cursor position recognition section 1001 is provided and the position coordinates designated by a cursor 1102 on a display screen 1101 are always recognized. This embodiment includes a correspondence table 1002 in which an area defined by dividing the screen and link destinations indicated in the area are related to each other. For example, the relationship between a particular area 1103 shown in FIG. 11(a) and link destinations (URLs) indicated in the particular area 1103 is indicated in the correspondence table 1002. More specifically, as shown in FIG. 11(c), the particular area 1103 is defined in such a manner that an upper left start point and a lower right end point in a rectangular area are represented by x- and y-coordinates. URLs (files) indicated in this area are stored. This correspondence table 1002 is updated each time the cursor 1102 is moved exceeding a certain extent. More specifically, the correspondence table 1002 is rewritten according to a resource read out from the on-screen image holding section 8 on the basis of the coordinates of a position to which the cursor is moved.

The operation analysis section 10 checks (1003) whether the cursor 1102 is located within the particular area 1103 on the basis of information from the cursor position recognition section 1001 and the correspondence table 1002, and checks (1004) whether the cursor 1102 has stayed within the particular area 1103 for a certain time period on the basis of information from a timer (which is not shown in FIG. 10, and which may be the same as the timer 81 shown in FIG. 8) and from the result of checking as to whether the cursor 1102 is located within the particular area 1103. If the cursor 1102 stays within the particular area 1103, the operation analysis section 10 notifies the URL temporary storage section 3 of the URLs (files) indicated in the particular area 1103 by referring to the correspondence table 1002. The URL temporary storage section 3 executes accessing the server 1 on the basis of the URLs (files). The URL (file 92) indicated in the particular area 1103 is thereby downloaded and held in the invisible on-screen data area 7a constituting the invisible on-screen data holding section 7, as shown in FIG. 11 (b). Processing in the file analysis section 6 at this time is the same as that in the above-described first and second embodiments, and the description for it will not be repeated.

This embodiment relates to a technique for prereading a URL (file) indicated in a display screen area where a cursor is positioned in a plurality of screen areas divided in the form of frames, for example.

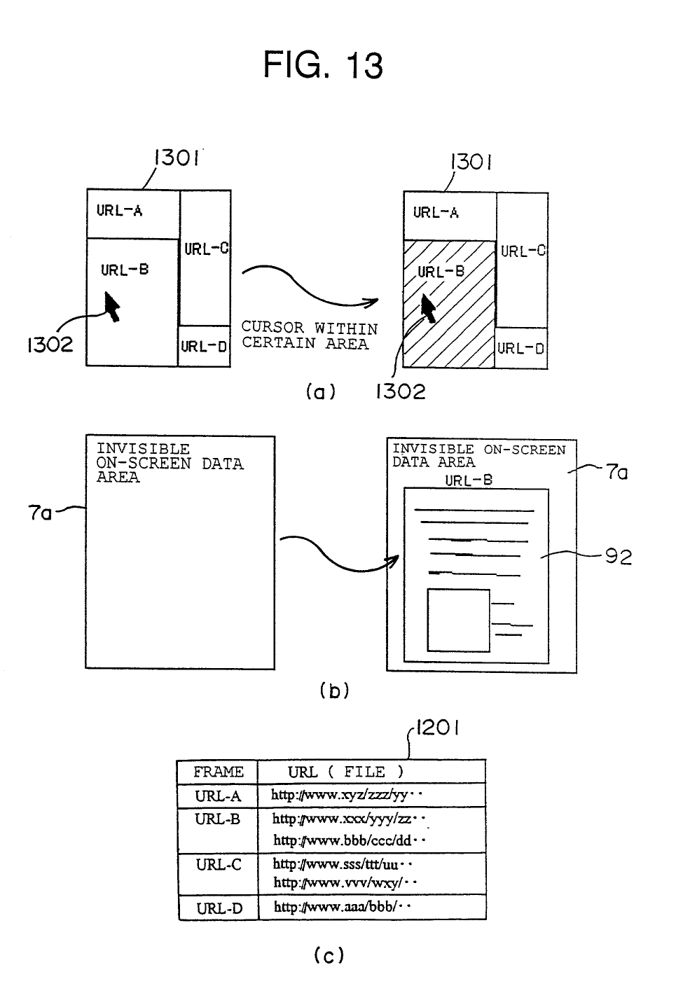

This embodiment includes a correspondence table 1201 showing the relationship between each of the divided frames on the screen and URLs (files) indicated in the frame. In this correspondence table 1201, as shown in FIG. 13(c), URLs (files) respectively indicated in the four divided frames (URL-A, URL-B, URL-C, and URL-D) on a display screen 1301 formed on the display unit 11 are to be registered.

In this embodiment, when the cursor position recognition section 1001 recognizes the position of a cursor 1302, the URLs (files) contained in the frame (URL-B in the example shown in FIG. 13(a)) in which the cursor 1302 is positioned are detected from the correspondence table 1201 (1202).

The URL (files) thereby detected are stored in the URL temporary storage section 3 and accessing the server 1 is executed. Consequently, the URLs (file 92) indicated in the frame URL-B are downloaded and held in the invisible on-screen data area 7a constituting the invisible on-screen data holding section 7, as shown in FIG. 13(b). Processing in the file analysis section 6 at this time is the same as that in the above-described first to third embodiments, and the description for it will not be repeated.

This embodiment is characterized by a technique for prereading files in the same directory. In this description, “directory” denotes a hierarchical structure of files or holders. Files at the same hierarchical level are preread.

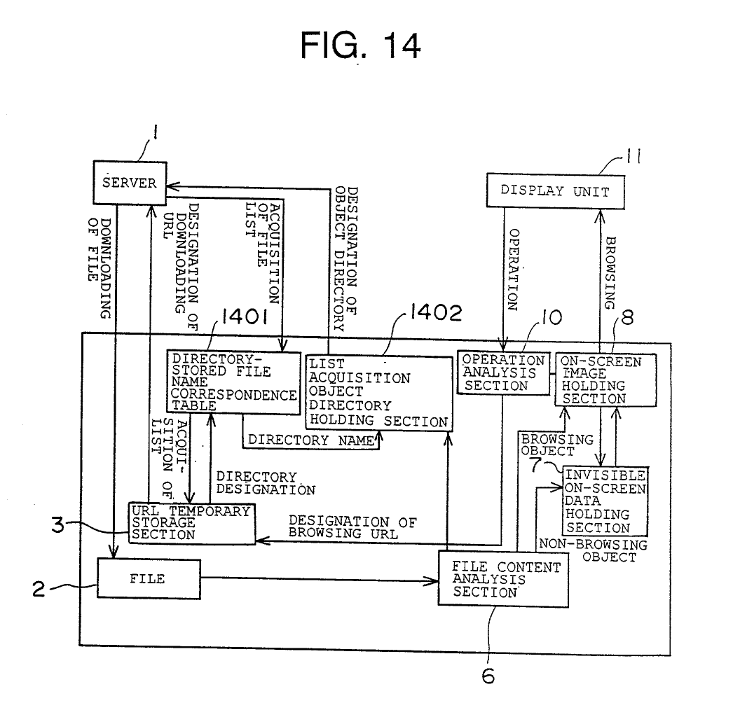

In the fifth embodiment, as shown in FIG. 14, a directory and a file list are obtained from a URL from server 1 in a correspondence table 1401 when the URL temporary storage section 3 access the server 1.

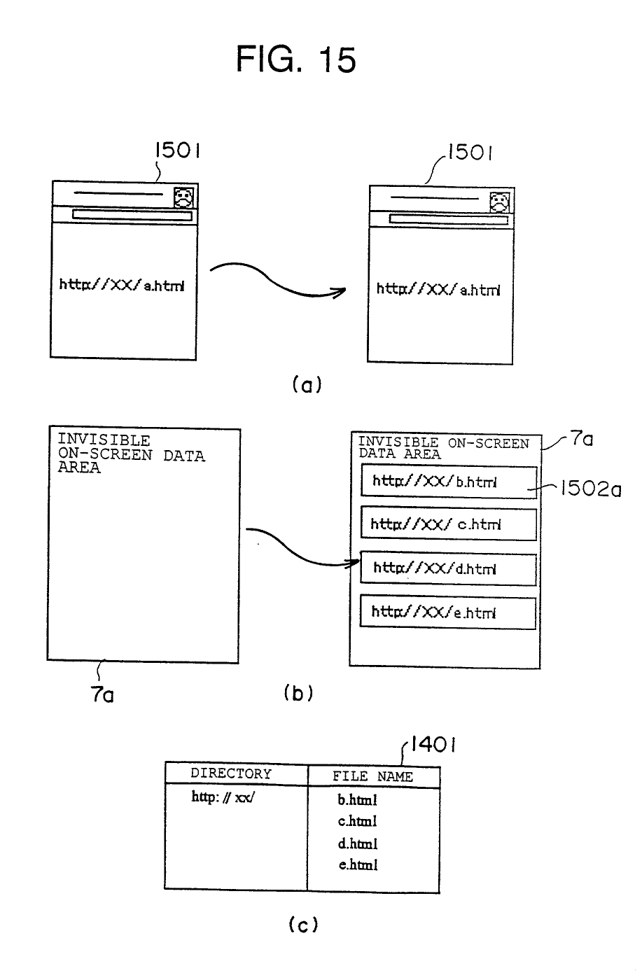

FIG. 15(c) shows the correspondence table 1401. As shown in FIG. 15(c), the correspondence table 1401 is provided as a directory-stored file name correspondence table in which a directory (here, http://xx/) and stored file names (b.html, c.html, d.html, e. html) contained in the directory are related.

A directory holding section 1402 holds the directory read out from the correspondence table 1401 and accesses the server 1 to collectively download the files contained in the directory. The files thus downloaded are analyzed by the file content analysis section 6 and loaded into the invisible onscreen data holding section 7 or the on-screen image holding section 8. This processing is the same as that in the above-described first to fourth embodiments and the description for it will not be repeated.

FIG. 15(a) shows a display screen 1501 of the display unit 11, and FIG. 15(b) shows a state where files (1502a, etc.) contained in the same directory (http://xx/) loaded into the invisible on-screen data area 7a are loaded.

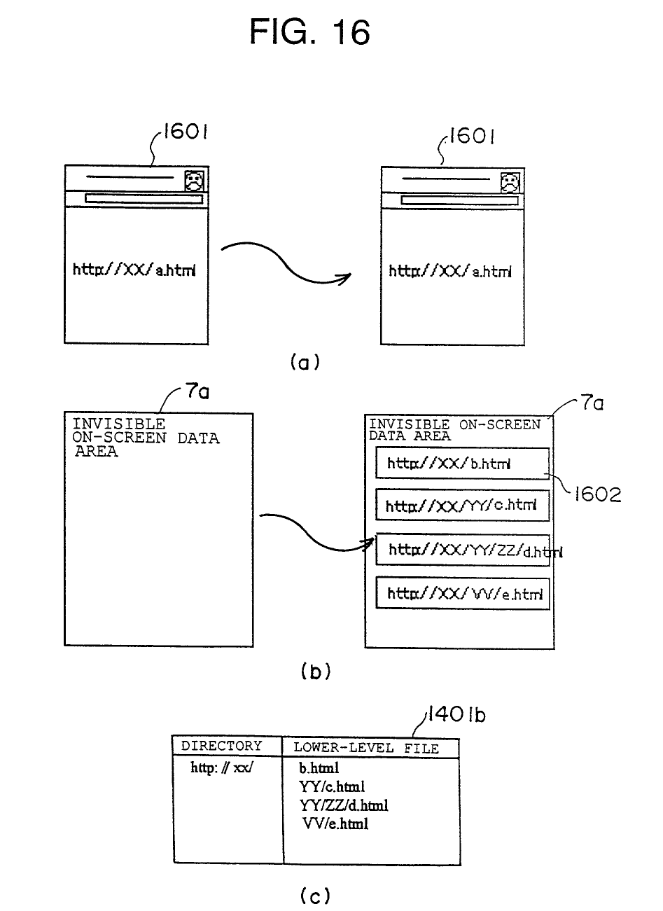

According to the above-description, files at a hierarchical level immediately subordinate to one directory (http://xx/) are related to each other in the correspondence table 1401. However, the hierarchical structure may alternatively be such that, as shown in FIG. 16(c), files (b.html, YY/c.html, YY/ZZ/d.html, VV/e.html) existing in all directories subordinate to one higher-level directory are related to each other in a correspondence table 1401b. In such a case, all lower-level files 1602 relating to one higher-order directory (http://xxx/) are preread to be loaded into the invisible on-screen data area 7a, as shown in FIG. 16(b).

Files set subordinate to one directory are highly provable to be read out by a user operation even if they differ in hierarchical level from each other. Therefore, loading of such files into the invisible on-screen data area 7a contributes to efficient display on the display unit 11.

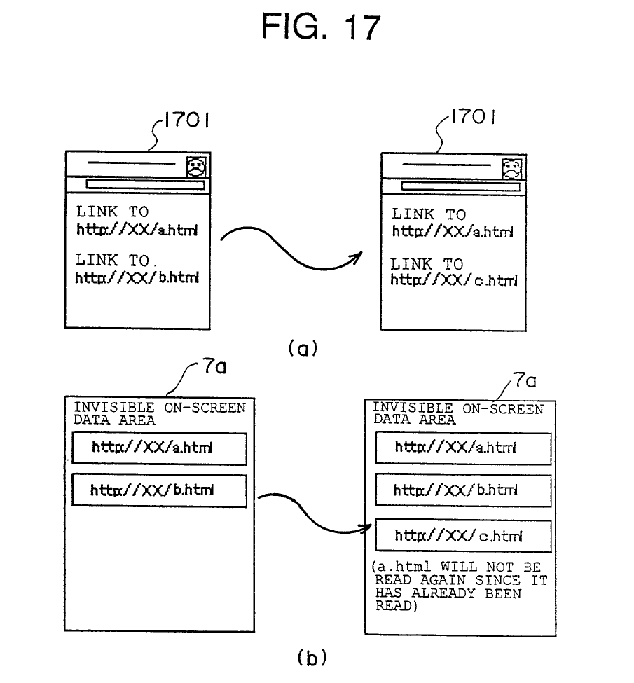

FIGS. 17(a) and 17(b) are diagrams showing a display screen 1701 of the display unit 11 and changes in the loaded states of files in the invisible on-screen data area 7a. Referring to the left section of FIG. 17(b), two files http://xx/a.html and http://xx/b.html have been read as preread files. It is assumed here that a need has arisen to newly preread three files (http://xx/a.html, http://xx/b.html, and http://xx/c.html) to the invisible on-screen data area 7a, when the display content of the display unit 11 is updated by a user's operation, under the preread condition corresponding to that described with respect to any one of the first to fifth embodiments. In such a case, since the two files (http://xx/a.html and http://xx/b.html) have already been read to the invisible on-screen data area 7a, they are not reread. only the file (http://xx/c.html) not previously read to the invisible on-screen data area 7a is read to this area.

Thus, the contents of the invisible on-screen data area 7a are not entirely refreshed with respect to display contents of the display unit 11. If there is some file common to the group of files preread on the basis of the display before the display is changed and the group of files to be preread on the basis of the changed display, only the files other than the common file are read. In this manner, the display speed can be further increased.

Each of the embodiments has been described with respect to a case where prereading of files is performed in such a manner that expected preread files are previously loaded into the invisible on-screen data holding section 7 (invisible onscreen data area 7a) without being perceived by the user reading the display on the display unit 11. Alternatively, the user may be notified of such file prereading through a change in a displayed image.

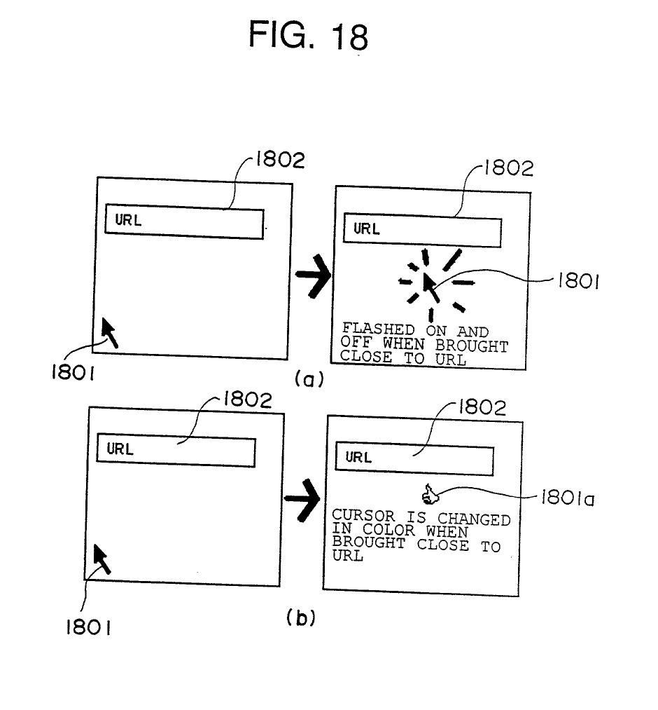

FIG. 18(a) shows an example of such notifying in which when the user operates the mouse so as to bring a cursor 1801 closer to a URL (another file) which should be preread, the cursor itself is flashed on and off (blinked) to notify the user of execution of prereading. Alternatively, the shape of the cursor itself may be changed from an arrow figure to a finger FIG. (1801a), as shown in FIG. 18(b). Such a visual change of the cursor 1801 can easily be made in such a manner that the operation analysis section 10 recognizes the cursor position on the basis of information from the cursor position recognition section 1001, to change the top address of a character code comprising a plurality of cursor shapes.

What is claimed is:

1. A network browser comprising:
an analysis module of analyzing a display control file of managing a display screen to extract a description of another file;
a downloading module of downloading from a server said another file identified by the analysis means;
a first loading module of loading said another file which has been downloaded onto an invisible screen; and
a display module of executing or displaying said another file loaded into the invisible screen without downloading said another file when said another file in the display control file is designated on the display screen.

2. A network browser according to claim 1, wherein said analysis module includes a second loading module of loading another module when said another file requires said another module of execution or display of said another file.

3. A network browser according to claim 1, wherein said analysis module has:
a work list in which work file names are stacked;
an analysis target list in which names of files which need analysis are stacked; and
a non-analysis-target list in which names of files which need no analysis are stacked,
wherein when a file name read out from the work list does not coincide with any of the file names stacked in the non-analysis-target list, it is stacked in the analysis target list, and the file names stacked in the analysis target list are successively read out to execute accessing a server on the basis of the file names read out.

4. A network browser according to claim 3, wherein said analysis module accesses the server on the basis of each of the file names stacked in the analysis target list, and stacks each file name in the non-analysis-target list after the corresponding file has been downloaded.

5. A network browser according to claim 1, wherein said analysis module monitors an operation on the display screen and starts analysis of the display control file or downloading of said another file if no operation on the display screen has been performed during a certain time period.

6. A network browser according to claim 1, wherein said analysis module monitors coordinate designation means on the display screen and starts analysis of the display control file or downloading of said another file if said coordinate designation means has stayed within a certain area during a certain time period.

7. A network browser according to claim 6, further comprising a correspondence table in which said certain area and file names indicated in said certain area and extracted from the display control file are related to each other, wherein said analysis means determines said another file to be downloaded by referring to said table.

8. A network browser according to claim 7, wherein said certain area is one of the screen areas divided in the form of frames, and said correspondence table is formed by respectively relating the screen area and other files set with respective screen areas and indicated on the display control file.

9. A network browser according to claim 1, wherein said analysis module collectively downloads from the server a plurality of files placed subordinate to one higher-level directory as said other files.

10. A network browser according to claim 9, wherein said other files include files placed at different subordinate hierarchical levels as well as those placed at the same hierarchical level subordinate to one higher-level directory.

11. A network browser according to claim 9 or 10, wherein said analysis module has a correspondence table in which a high-level directory and files at a lower-hierarchical level are related to each other, and determines a file as another file to be downloaded by referring to the correspondence table.

12. A network browser according to claim 1, wherein the invisible screen is updated each time the display control file of controlling the display screen is changed, and updating of the invisible screen is not performed if another file loaded before an updating change and still another file to be loaded after the displaying change are identical to each other.

13. A network browser according to claim 1, wherein said analysis module gives a visual notice by changing the display on the display screen when starting analysis of the display control file or downloading of another file.

14. A network browser according to claim 13, wherein the change in the display on the display screen comprises a visual change of coordinate designation means displayed on the display screen.

15. A method for display using a network browser comprising the steps of:
analyzing a display control file for managing a display screen to extract a description of another file;
downloading from a server said another file identified by the analysis module;
loading said downloaded another file onto an invisible screen; and
executing or displaying said another file loaded into the invisible screen without downloading said another file when said another file in the display control file is designated on the display screen.

16. A method for display using a network browser according to claim 15, wherein at the time of said analysis, if said another file requires another module to execute or display said another file, said another module is loaded.

17. A method for display using a network browser according to claim 15, wherein at the time of said analysis, an operation on the display screen is monitored and analysis of the display control file or downloading of said another file is started if no operation on the display screen has been performed during a certain time period.

18. A method for display using a network browser according to claim 15, wherein at the time of said analysis, coordinate designation means on the display screen is monitored and analysis of the display control file or downloading of said another file is started if said coordinate designation means has stayed within a certain area during a certain time period.

19. A computer-executable storage medium comprising a program stored thereon, said program of performing a process comprising:
analyzing a display control file of managing a display screen to extract a description of another file;
downloading from a server said another file identified by the analysis module;
loading said another file onto an invisible screen; and
executing or displaying said another file loaded into the invisible screen without downloading said another file when said another file in the display control file is designated on the display screen.

20. A computer-executable storage medium according to claim 19, wherein at the time of said analysis, if said another file requires another module of execution or display of said another file, said another module is loaded.

21. A computer-executable storage medium according to claim 19, wherein at the time of said analysis, an operation on the display screen is monitored and analysis of the display control file or downloading of said another file is started if no operation on the display screen has been performed during a certain time period.

22. A computer-executable storage medium according to claim 19, wherein at the time of said analysis, coordinate designation means on the display screen is monitored and analysis of the display control file or downloading of said another file is started if said coordinate designation means has stayed within a certain area during a certain time period.
